(19) United States
(12) Patent Application Publication
(10) Pub. No.: US 2018/0233021 A1
(43) Pub. Date: Aug. 16, 2018

(54) ALERT PROPAGATION IN A VIRTUALIZED COMPUTING ENVIRONMENT

(71) Applicant: International Business Machines Corporation, Armonk, NY (US)

(72) Inventors: Daniel L. Hiebert, Montrose, CO (US); Raymond S. Perry, Rochester, MN (US); Jeffrey W. Tenner, Rochester, MN (US); Sneha M. Varghese, Fishkill, NY (US)

(21) Appl. No.: 15/430,275

(22) Filed: Feb. 10, 2017

(51) Int. Cl. G08B 21/18; G06F 9/455

(52) U.S. Cl. CPC G08B 21/187; G06F 2009/45595; G06F 2009/45591; G06F 9/45558

(57) ABSTRACT

Techniques are described relating to alert propagation in a virtualized computing environment. An associated method may include receiving a notification regarding an incident in an environment in which computing capabilities are provided as a service. The method further may include monitoring a plurality of events within the environment to detect an event relating to the incident and evaluating the detected event. The method further may include propagating via at least one alerting site service at least one disruption alert associated with the incident. The at least one disruption alert may be based upon evaluating the detected event. The at least one alerting site service may distribute the at least one disruption alert to at least one alerting agent among a plurality of alerting agents, each of the at least one alerting agent being associated with a respective virtual machine within the environment that is affected by the incident.

### BACKGROUND

The various embodiments described herein generally relate to alert propagation in a virtualized computing environment. More specifically, the various embodiments describe techniques of propagating via at least one alerting site service at least one alert associated with an incident in a virtualized environment, e.g., an environment in which computing capabilities are provided as a service.

In a managed virtualized environment, various services may be provided to ensure the security, stability, and performance of virtualized endpoints. Such services may include antivirus coverage, disaster recovery, patching, backup, and health monitoring. In certain instances, communication between a management component and a guest operating system of a virtual machine within such virtualized environment may be disrupted, thus rendering alerting with regard to any incident difficult.

### SUMMARY

The various embodiments described herein provide techniques of alert propagation. An associated method may include receiving a notification regarding an incident in an environment in which computing capabilities are provided as a service. The reception of the notification may be effected via at least one processor. Furthermore, the reception of the notification may be effected via a network. The method further may include monitoring a plurality of events within the environment to detect an event relating to the incident and evaluating the detected event. The method further may include propagating via at least one alerting site service at least one disruption alert associated with the incident. The at least one disruption alert may be based upon evaluating the detected event. The at least one alerting site service may distribute the at least one disruption alert to at least one alerting agent among a plurality of alerting agents, each of the at least one alerting agent being associated with (e.g., installed at) a respective virtual machine within the environment that is affected by the incident.

Optionally, the method further may include, upon resolution of the incident, propagating via the at least one alerting site service at least one resumption alert. According to an embodiment, the method may include propagating at least one anticipated alert responsive to a predictive alert technique based upon analysis of historical trends. According to a further embodiment, the method may include propagating at least one anticipated alert responsive to a failure of at least one element within the environment. In a further embodiment, the method step of evaluating the detected event may include determining attributes of the detected event, calculating a probability value indicating potential impact severity with respect to the detected event, and registering the detected event.

In an embodiment, the at least one alerting agent may be registered to at least one designated alerting site service among the at least one alerting site service such that the at least one designated alerting site service processes the at least one disruption alert by automatically triggering at least one action customized to at least one guest operating system application of any respective virtual machine within the environment that is associated with the at least one alerting agent. In a further embodiment, the at least one alerting site service may trigger a unique action based upon alert type.

In an embodiment, the environment may include a plurality of virtual machines. According to such embodiment, each virtual machine may include a guest operating system and may be associated with one of a plurality of clients. In a further embodiment, the at least one disruption alert may be specific to any respective guest operating system associated with the at least one alerting agent.

An additional embodiment includes a computer program product including a computer readable storage medium having program instructions embodied therewith. According to such embodiment, the program instructions may be executable by a computing device to cause the computing device to perform one or more steps of above recited method. A further embodiment includes a system having a processor and a memory storing an application program, which, when executed on the processor, performs one or more steps of the above recited method.

### BRIEF DESCRIPTION OF THE DRAWINGS

So that the manner in which the above recited aspects are attained and can be understood in detail, a more particular description of embodiments, briefly summarized above, may be had by reference to the appended drawings.

Note, however, that the appended drawings illustrate only typical embodiments of this invention and are therefore not to be considered limiting of its scope, for the invention may admit to other equally effective embodiments.

FIG. 1 depicts a cloud computing environment, according to an embodiment.

FIG. 2 depicts abstraction model layers provided by a cloud computing environment, according to an embodiment.

FIG. 3 illustrates an alerting topology of a cloud computing environment, according to an embodiment.

FIG. 4 illustrates a method of propagating at least one alert associated with an incident, according to an embodiment.

FIG. 5 illustrates a method of evaluating a detected event relating to an incident, according to an embodiment.

### DETAILED DESCRIPTION

The various embodiments described herein are directed to techniques of alert propagation in a virtualized environment in which computing capabilities are provided as a service (e.g., a cloud computing environment). Specifically, the various embodiments are directed to an alerting topology. The alerting topology may include an alerting manager configured to propagate at least one alert. The alerting topology further may include at least one alerting site service established to coordinate alerts to individual virtualized endpoints. The alerting topology further may include at least one alerting agent registered to an alerting site service among the at least one alerting site service. Accordingly, the alerting site service to which the at least one alerting agent is registered may trigger at least one action customized to at least one guest operating system application of any respective virtualized endpoint associated with the at least one alerting agent.

The virtualized endpoints may be virtual machines. In such case, the environment in which computing capabilities are provided as a service may include a plurality of virtual machines. According to such embodiment, each virtual machine may include a guest operating system and may be associated with one of a plurality of clients.

The various embodiments described herein may have advantages over conventional techniques. Specifically, the various embodiments enable virtualized endpoints to register to alerting site services such that customized actions may be triggered automatically with respect to at least one guest operating system application based on alerts propagated via an alerting topology. Furthermore, the various embodiments may enable propagation of anticipated alerts based upon analysis of historical trends. Additionally, the various embodiments may enable an alerting manager to propagate alerts to any virtualized endpoint affected by an incident while excluding any virtualized endpoint not affected by the incident. Moreover, the various embodiments may enable an alerting manager to determine a probability value indicating potential impact severity with respect to a detected event relating to an incident. Some of the various embodiments may not include all such advantages, and such advantages are not necessarily required of all embodiments.

In the following, reference is made to various embodiments of the invention. However, it should be understood that the invention is not limited to specific described embodiments. Instead, any combination of the following features and elements, whether related to different embodiments or not, is contemplated to implement and practice the invention. Furthermore, although embodiments may achieve advantages over other possible solutions and/or over the prior art, whether or not a particular advantage is achieved by a given embodiment is not limiting. Thus, the following aspects, features, embodiments, and advantages are merely illustrative and are not considered elements or limitations of the appended claims except where explicitly recited in a claim(s) Likewise, reference to “the invention” shall not be construed as a generalization of any inventive subject matter disclosed herein and shall not be considered to be an element or limitation of the appended claims except where explicitly recited in a claim(s).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions also may be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions also may be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Particular embodiments describe techniques relating to alert propagation in a virtualized computing environment. However, it is to be understood that the techniques described herein may be adapted to a variety of purposes in addition to those specifically described herein. Accordingly, references to specific embodiments are included to be illustrative and not limiting.

The various embodiments described herein may be provided to end users through a cloud computing infrastructure. It is to be understood that although this disclosure includes a detailed description on cloud computing, implementation of the teachings recited herein are not limited to a cloud computing environment. Rather, the various embodiments described herein are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. Thus, cloud computing allows a user to access virtual computing resources (e.g., storage, data, applications, and even complete virtualized computing systems) in the cloud, without regard for the underlying physical systems (or locations of those systems) used to provide the computing resources. This cloud model may include at least five characteristics, at least three service models, and at least four deployment models.

Characteristics are as follows:

On-demand self-service: A cloud consumer can unilaterally provision computing capabilities, such as server time and network storage, as needed automatically without requiring human interaction with the provider of the service.

Broad network access: Capabilities are available over a network and accessed through standard mechanisms that promote use by heterogeneous thin or thick client platforms (e.g., mobile phones, laptops, and personal digital assistants (PDAs)).

Resource pooling: The computing resources of the provider are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: Capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: Cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): The capability provided to the consumer is to use the applications of the provider running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): The capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): The capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: The cloud infrastructure is operated solely for an organization. It may be managed by the organization or a third party and may exist on-premises or off-premises.

Community cloud: The cloud infrastructure is shared by several organizations and supports a specific community that has shared concerns (e.g., mission, security requirements, policy, and compliance considerations). It may be managed by the organizations or a third party and may exist on-premises or off-premises.

Public cloud: The cloud infrastructure is made available to the general public or a large industry group and is owned by an organization selling cloud services.

Hybrid cloud: The cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

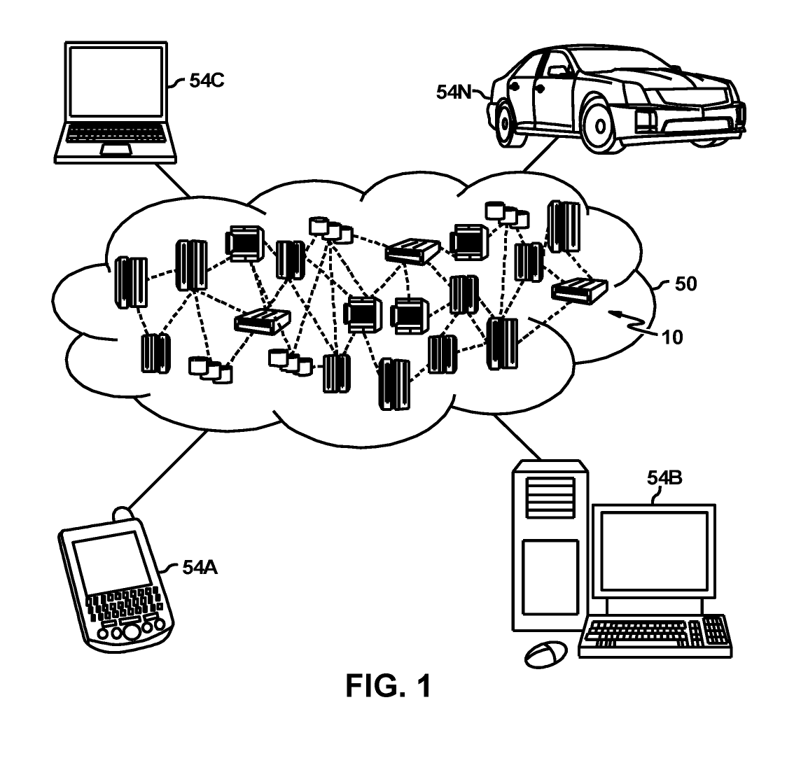

Referring now to FIG. 1, illustrative cloud computing environment 50 is depicted. As shown, cloud computing environment 50 may include one or more cloud computing nodes 10 with which local computing devices used by cloud consumers, such as, for example, PDA or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. Accordingly, cloud computing environment 50 may offer infrastructure, platforms, and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

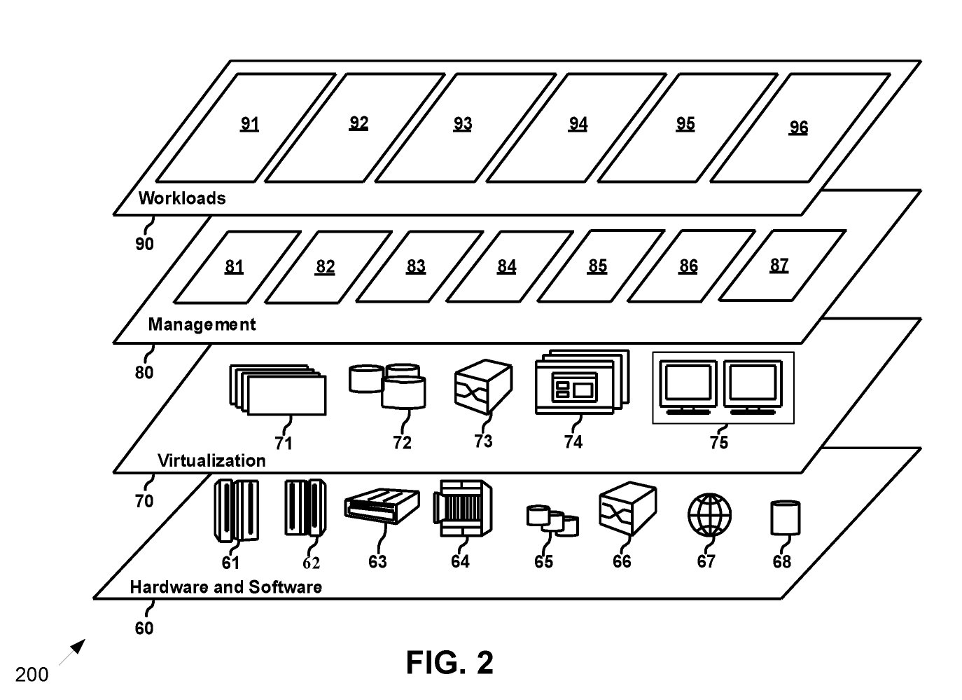

Referring now to FIG. 2, a set of functional abstraction layers provided by cloud computing environment 50 is shown. It should be understood in advance that the components, layers, and functions shown in FIG. 2 are intended to be illustrative only; embodiments of the invention are not limited thereto. As depicted, various layers and corresponding functions are provided. Specifically, hardware and software layer 60 includes hardware and software components. Examples of hardware components may include mainframes 61, RISC (Reduced Instruction Set Computer) architecture based servers 62, servers 63, blade servers 64, storage devices 65, and networks and networking components 66. In some embodiments, software components may include network application server software 67 and database software 68. Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 may provide dynamic procurement of computing resources and other resources that are utilized to perform tasks within the cloud computing environment. Metering and pricing 82 may provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 may provide access to the cloud computing environment for consumers and system administrators. Service level management 84 may provide cloud computing resource allocation and management such that required service levels are met. Service Level Agreement (SLA) planning and fulfillment 85 may provide pre-arrangement for, and procurement of, cloud computing resources for which a future requirement is anticipated in accordance with an SLA. Alerting management 86 may enable alerting services in accordance with the various embodiments described herein. At least one alerting site service function 87 may enable propagation of alerts enabled by alerting management 86.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and mobile desktop computing 96.

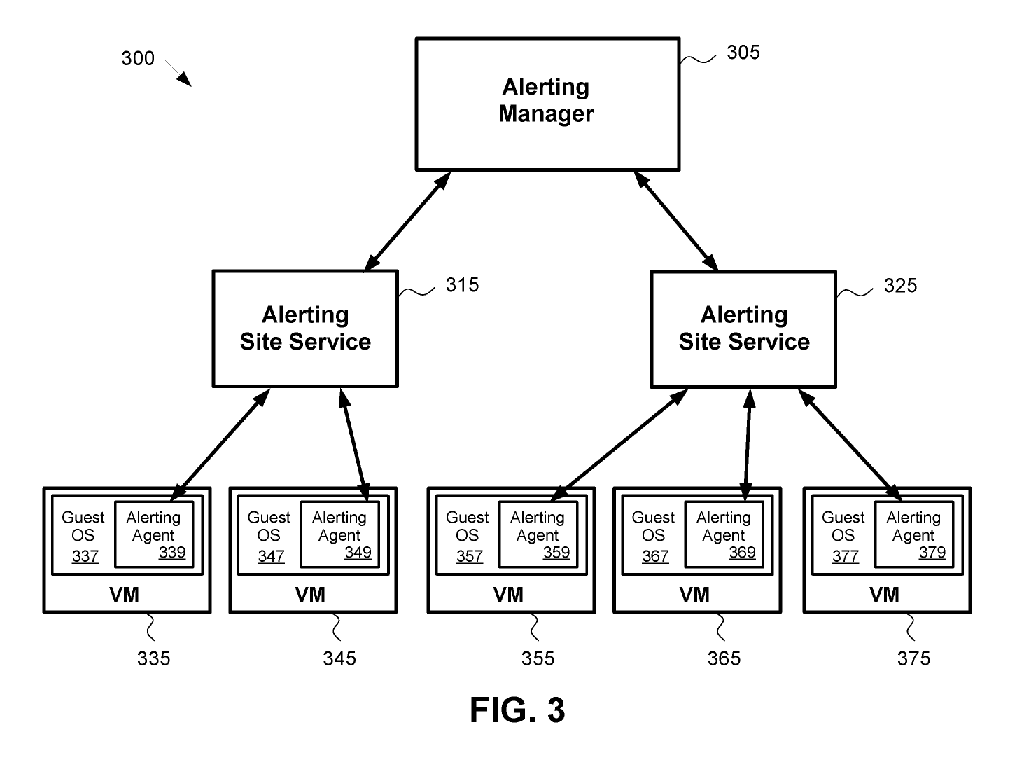

FIG. 3 illustrates an alerting topology 300 of cloud computing environment 50, according to an embodiment. Alerting topology 300 may include alerting manager 305. Alerting manager 305 is an example of alerting management 86 in the context of FIG. 2. Alerting manager 305 may communicate with alerting site services 315 and 317. Alerting site services 315 and 317 are examples of an alerting site service function 87 in the context of FIG. 2.

Alerting site service 315 may be associated with a plurality of virtual machines 335 and 345. Virtual machine 335 may include an alerting agent 339 within a guest operating system 337, and virtual machine 345 may include an alerting agent 349 within a guest operating system 347. Alerting site service 317 may be associated with a plurality of virtual machines 355, 365, and 375. Virtual machine 355 may include an alerting agent 359 within a guest operating system 357, virtual machine 365 may include an alerting agent 369 within a guest operating system 367, and virtual machine 375 may include an alerting agent 379 within a guest operating system 377. Although alerting site services 315 and 317 are illustrated in FIG. 3, alerting topology 300 may include any number of alerting site services. Furthermore, although two virtual machines are associated with alerting site service 315 and three virtual machines are associated with alerting site service 317 in the context of FIG. 3, alerting site services 315 and 317 respectively may be associated with any number of virtual machines and corresponding alerting agents.

Alerting manager 305 in alerting topology 300 may propagate one or more alerts regarding an incident detected in cloud computing environment 50. The one or more alerts may address incidents with respect to storage, capacity, networking, physical hardware, and/or cloud management (e.g., OpenStack). In the context of cloud computing environment 50, alerting manager 305 may be located at a central site and may include topology information with regard to relationships among virtualization entities, storage entities, hosts, and networks. The alerting site services in alerting topology 300 (e.g. alerting site service 315) may coordinate alerts propagated by alerting manager 305 to the respective guest operating systems of one or more virtual machines in cloud computing environment 50 (e.g., guest operating system 337 of virtual machine 335). In an embodiment, in the event that connection with alerting manager 305 is lost, one or more of the alerting site services may serve as a substitute to alerting manager 305 by detecting incidents and issuing alerts.

Respective alerting agents in alerting topology 300 (e.g., alerting agent 339) may be installed upon deployment of the respective virtual machines. In the context of cloud computing environment 50, the respective alerting site services and alerting agents may be located at sites where managed servers are deployed. The respective alerting agents may be registered to at least one designated alerting site service among the alerting site services. As a result of such registration, the at least one designated alerting site service may process alerts associated with respective virtual machines on which the respective alerting agents are installed by automatically triggering at least one action customized to one or more applications of the guest operating systems of the respective virtual machines. For example, alerting agent 339 may be registered to alerting site service 315, and consequent to such registration alerting site service 315 may process alerts associated with virtual machine 335 on which alerting agent 339 is installed by automatically triggering at least one action customized to one or more applications of guest operating system 337 of virtual machine 335. As another example, alerting agent 369 may be registered to alerting site service 325.

According to an embodiment, as a result of the installed alerting agents, one or more applications of the guest operating systems of the respective virtual machines in alerting topology 300 may subscribe to a signal notification system associated with an alerting site service (e.g., Linux Signals). Such signal notification system may provide signals at the application level to trigger application actions based upon respective alerts. In the aforementioned example, one or more applications of guest operating system 337 of virtual machine 335 may subscribe to such signal notification system.

Furthermore, an alerting site service may be capable of triggering a unique action based upon alert type. For instance, an alerting site service may trigger an action to suspend, stop, or terminate a particular function based upon respective types of disruption alerts. Furthermore, the alerting site service may trigger an action to resume a particular function based upon a resumption alert. Additionally, as a result of subscribing to a signal notification system associated with an alerting site service, one or more applications of the guest operating systems of the respective virtual machines may receive one or more alerts on a predetermined periodic basis or on an otherwise designated basis regarding one or more aspects of cloud computing environment 50 that are of particular relevance to the one or more applications.

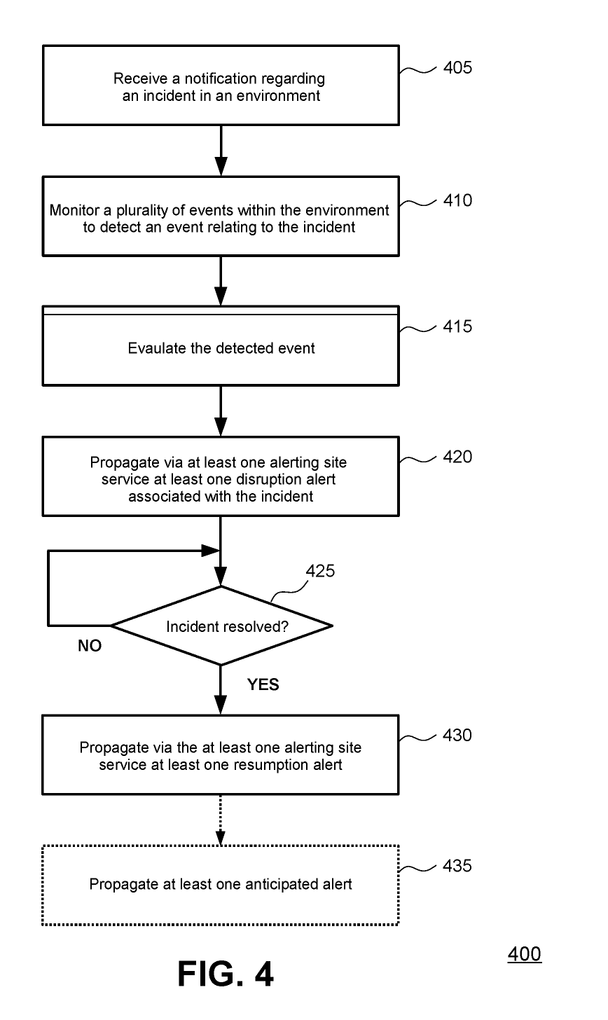

FIG. 4 illustrates an alert propagation method 400, according to an embodiment. One or more steps associated with the method 400 may be carried out in an environment in which computing capabilities are provided as a service (e.g., cloud computing environment 50). Additionally or alternatively, one or more steps associated with the method 400 may be carried out in other environments, such as a client-server network environment or a peer-to-peer network environment. An alerting manager (e.g., alerting manager 305) in an alerting topology (e.g., alerting topology 300) may facilitate processing according to the method 400 and the other methods further described herein. The alerting manager may be associated with an alerting management function within a management layer among functional abstraction layers provided by the environment (e.g., alerting management 86 within management layer 80 of cloud computing infrastructure 50).

The method 400 may begin at step 405, where the alerting manager may receive a notification regarding an incident in the environment. For example, such incident may involve loss of network communication. At step 410, the alerting manager may monitor a plurality of events within the environment to detect an event relating to the incident. Events within the environment may include network events, storage events, systems events, and site events. For instance, the event relating to the incident as detected at step 410 may be a network event such as a network capacity issue, a storage event such as a data store cluster of virtual machines running low on capacity, a systems event such as a software exception, or a site event such as site maintenance causing disruption to certain services. In an embodiment, events within the environment further may include stack management events based upon activities of a stack management tool (e.g., Kibana-based events, wherein Kibana is a tool that displays results based upon search of a stack created with open source based Elastic Stack). According to such embodiment, the alerting manager may detect logged events found via the stack management tool.

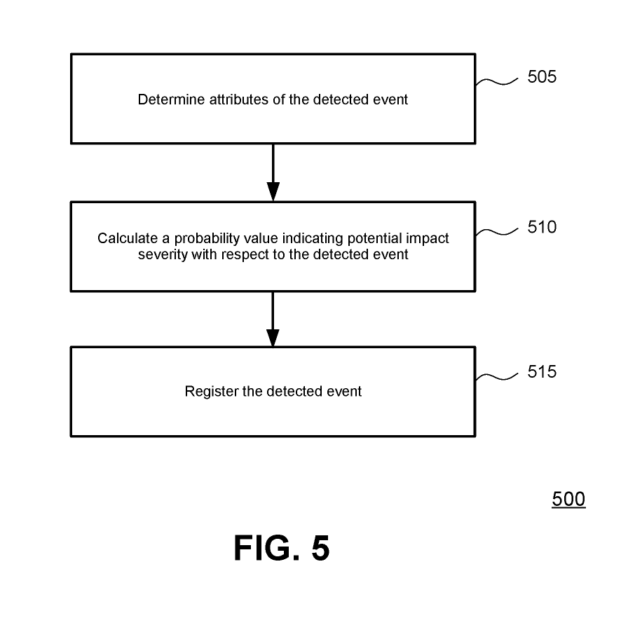

At step 415, the alerting manager may evaluate the detected event. An embodiment with regard to evaluating the detected event according to step 415 is described with respect to FIG. 5. By evaluating the detected event, the alerting manager may determine attributes of the detected event as well as the scope of the detected event in the context of the alerting topology. As further described herein, determination of the attributes and scope of the detected event may enable the alerting manager to assess the impact of the incident throughout the alerting topology.

At step 420, the alerting manager may propagate via at least one alerting site service in the alerting topology (e.g., alerting site services 315 and 317) at least one disruption alert associated with the incident. The at least one disruption alert may be based upon evaluating the detected event at step 415. The alerting manager may propagate the at least one disruption alert to one or more guest operating systems in the alerting topology based upon the attributes and the scope of the detected event. Specifically, the at least one alerting site service may distribute the at least one disruption alert to at least one alerting agent among a plurality of alerting agents in the alerting topology. In an embodiment, the at least one disruption alert may be specific to any respective guest operating system associated with the at least one alerting agent. Each of the at least one alerting agent to which the at least one disruption alert may be propagated may be installed at a respective virtual machine within the environment that is affected by the incident. That is to say, the alerting manager may propagate the at least one disruption alert to at least one alerting agent among the plurality of alerting agents associated with (i.e., installed on) the virtual machine(s) affected by the incident.

According to step 420, the alerting manager may pinpoint particular virtual machine(s) to which the at least one disruption alert should be distributed based upon the nature and scope of the event relating to the incident. Identifying particular virtual machine(s) according to the nature and scope of the event may ensure that only the guest operating system(s) of virtual machine(s) affected by the incident receive the at least one disruption alert. Accordingly, guest operating system(s) of virtual machine(s) unaffected by the incident may be excluded from receiving the at least one disruption alert.

In an embodiment, the at least one alerting agent to which the at least one disruption alert may be propagated at step 420 may be registered to at least one designated alerting site service among the at least one alerting site service. According to such embodiment, the at least one designated alerting site service may process the at least one disruption alert propagated at step 420 by automatically triggering at least one action customized to one or more applications of guest operating system(s) associated with the at least one alerting agent.

At step 425, the alerting manager may determine whether the incident has been resolved. Responsive to the alerting manager determining that the incident has not been resolved, the alerting manager may repeat step 425. Responsive to the alerting manager determining that the incident has been resolved, at step 430 the alerting manager may propagate via the at least one alerting site service at least one resumption alert. Similarly to propagation of the at least one disruption alert at step 420, the alerting manager may propagate the at least one resumption alert to at least one alerting agent among the plurality of alerting agents associated with (i.e., installed on) the virtual machine(s) affected by the incident.

Optionally, at step 435, the alerting manager may propagate at least one anticipated alert. Specifically, the alerting manager may propagate at least one anticipated alert to respective alerting agent(s) associated with one or more guest operating systems of respective virtual machines of the alerting topology. According to one embodiment, the alerting manager may propagate at least one anticipated alert responsive to a predictive alert technique based upon analysis of historical trends. According to a further embodiment, the alerting manager may propagate at least one anticipated alert responsive to a failure of at least one element within the environment (e.g., an environmental system or function). Specifically, the alerting manager may propagate at least one anticipated alert to respective alerting agent(s) associated with one or more guest operating systems of respective virtual machine(s) that may be affected by a failure within the environment. For instance, a hard drive failure could result in a disruption of one or more virtual machines reliant upon the hard drive, and in such case the alerting manager may propagate an anticipated alert to the affected virtual machine(s) by sending such alert to the alerting agent(s) associated with (i.e., installed on) one or more guest operating system(s) of the affected virtual machine(s). According to alternative embodiments, the alerting manager may propagate at least one anticipated alert according to step 435 prior to completion of one or more of the other steps of the method 400.

FIG. 5 illustrates a method 500 of evaluating a detected event, according to an embodiment. The method 500 provides an example embodiment with respect to step 415 of the method 400. The method 500 may begin at step 505, where the alerting manager may determine attributes of the detected event. Such attributes may include event type and event site (i.e., location of the event within the environment). Determining the event type and event site may enable the alerting manager to pinpoint which virtual machine(s) among the virtual machines in alerting topology 300 are likely affected and/or are definitely affected by the detected event.

At step 510, the alerting manager may calculate a probability value indicating potential impact severity with respect to the detected event. According to an embodiment, the alerting manager may store such probability value for purposes of historical trends analysis. Additionally or alternatively, the alerting manager may factor such probability value upon pinpointing which virtual machine(s) among the virtual machines in alerting topology 300 are likely affected and/or are definitely affected by the detected event. Moreover, according to the aforementioned embodiment with respect to stack management events, the alerting manager may complete probability analysis based upon logged events found via a stack management tool.

At step 515, the alerting manager may register the detected event. In an embodiment, registering the detected event may include acknowledging the event by recording details with respect to the event. Registration of the detected event may enable the alerting manager and/or other aspects of the alerting topology to store and access details of the detected event for various purposes, including propagating one or more anticipated alerts in accordance with step 435 of the method 400.

An example scenario with regard to an incident within alerting topology 300 may involve a loss of network communication. According to step 405 of the method 400, alerting manager 305 may receive a notification regarding the loss of network communication. According to step 410, alerting manager 305 may monitor a plurality of events within cloud computing environment 50 to detect a software exception event relating to the loss of network communication. According to step 415, and more specifically in accordance with the method 500, alerting manager 305 may evaluate the detected software exception event. According to step 505, alerting manager 305 may determine attributes of the detected software exception event, including specific details regarding the cause and nature of the software exception as well as the location within cloud computing environment 50 at which the software exception arose. According to step 510, alerting manager 305 may calculate a probability value indicating potential impact severity with respect to the detected software exception event. According to step 515, alerting manager 305 may register the detected software exception event so that details with respect to the software exception may be stored and accessed as appropriate.

Based upon evaluating the detected software exception event in the example scenario, according to step 420 alerting manager 305 may propagate via at least one alerting site service at least one disruption alert associated with the incident. Specifically, assuming that alerting manager 305 evaluates the detected software exception event and determines that services with respect to guest operating systems 337 and 347 in alerting topology 300 are affected, alerting manager 305 may propagate respective disruption alerts via alerting site service 315 to alerting agent 339 associated with guest operating system 337 of virtual machine 335 and to alerting agent 349 associated with guest operating system 347 of virtual machine 345. In the context of the example scenario, one or more applications of guest operating systems 337 and 347 may be subscribed to a signal notification system associated with alerting site service 315. Such signal notification system may provide one or more suspend signals at the application level to trigger suspension of one or more application activities affected by the detected software exception.

According to step 425 in the example scenario, alerting manager 305 may determine whether the network communication incident has been resolved. Responsive to alerting manager 305 determining that the incident has not been resolved, alerting manager 305 may repeat step 425. Responsive to alerting manager 305 determining that the incident has been resolved, according to step 430 alerting manager 305 may propagate via the at least one alerting site service at least one resumption alert. Specifically, according to the example scenario, alerting manager 305 may propagate respective resumption alerts via alerting site service 315 to alerting agent 339 associated with guest operating system 337 of virtual machine 335 and to alerting agent 349 associated with guest operating system 347 of virtual machine 345. Optionally, alerting manager 305 may propagate at least one anticipated alert according to step 435 based on historical trends analysis and/or responsive to a failure of at least one element within cloud computing environment 50.

Another example scenario with regard to an incident within alerting topology 300 may involve a failure to save data within a particular data store cluster. Alerting manager 305 may address the data incident according to the alerting propagation techniques described in methods 400 and 500. Specifically, alerting manager 305 may detect and evaluate an event relating to the incident. Assuming that the event in this scenario pertains to a data store cluster running low on capacity, alert manager 305 may propagate at least one disruption alert regarding the capacity issue to the respective alerting agent(s) associated with the virtual machine(s) in alerting topology 300 affected by the incident, i.e., the virtual machine(s) using disk space in the particular data store cluster. Responsive to alerting manager 305 determining that the incident has been resolved (i.e., data can be saved within the particular data store cluster due to resolution of the capacity issue), alerting manager 305 may propagate at least one resumption alert to the respective alerting agent(s) associated with the virtual machine(s) affected by the incident.

A further example scenario with regard to an incident within alerting topology 300 may involve disruption of certain site services. Alerting manager 305 may address the service incident according to the alerting propagation techniques described in the methods 400 and 500. Specifically, alerting manager 305 may detect and evaluate an event relating to the incident. Assuming that the event in this scenario pertains to site maintenance activities, alert manager 305 may propagate at least one disruption alert regarding the maintenance activities to the respective alerting agent(s) associated with the virtual machine(s) in alerting topology 300 affected by the incident, i.e., the virtual machine(s) having access to the site services affected by the maintenance activities. Responsive to alerting manager 305 determining that the incident has been resolved (i.e., site services have been restored following the conclusion of the maintenance activities), alerting manager 305 may propagate at least one resumption alert to the respective alerting agent(s) associated with virtual machine(s) affected by the incident.

The descriptions of the various embodiments of the present invention have been presented for purposes of illustration but are not intended to be exhaustive or limited to the embodiments disclosed. All kinds of modifications made to the described embodiments and equivalent arrangements should fall within the protected scope of the invention. Hence, the scope of the invention should be explained most widely according to the claims that follow in connection with the detailed description, and should cover all possibly equivalent variations and equivalent arrangements. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method comprising:
receiving, via at least one processor, a notification regarding an incident in an environment in which computing capabilities are provided as a service;
monitoring a plurality of events within the environment to detect an event relating to the incident;
evaluating the detected event; and
propagating via at least one alerting site service at least one disruption alert associated with the incident, wherein the at least one disruption alert is based upon evaluating the detected event, and wherein the at least one alerting site service distributes the at least one disruption alert to at least one alerting agent among a plurality of alerting agents, each of the at least one alerting agent being associated with a respective virtual machine within the environment that is affected by the incident.

2. The method of claim 1, further comprising:
upon resolution of the incident, propagating via the at least one alerting site service at least one resumption alert.

3. The method of claim 1, further comprising:
propagating at least one anticipated alert responsive to a predictive alert technique based upon analysis of historical trends.

4. The method of claim 1, further comprising:
propagating at least one anticipated alert responsive to a failure of at least one element within the environment.

5. The method of claim 1, wherein evaluating the detected event comprises:
determining attributes of the detected event;
calculating a probability value indicating potential impact severity with respect to the detected event; and
registering the detected event.

6. The method of claim 1, wherein the at least one alerting agent is registered to at least one designated alerting site service among the at least one alerting site service such that the at least one designated alerting site service processes the at least one disruption alert by automatically triggering at least one action customized to at least one guest operating system application of any respective virtual machine within the environment that is associated with the at least one alerting agent.

7. The method of claim 1, wherein the at least one alerting site service triggers a unique action based upon alert type.

8. The method of claim 1, wherein the environment comprises a plurality of virtual machines, and wherein each virtual machine includes a guest operating system and is associated with one of a plurality of clients.

9. The method of claim 1, wherein the at least one disruption alert is specific to any respective guest operating system associated with the at least one alerting agent.

10. A computer program product comprising a computer readable storage medium having program instructions embodied therewith, the program instructions executable by a computing device to cause the computing device to:
receive a notification regarding an incident in an environment in which computing capabilities are provided as a service;
monitor a plurality of events within the environment to detect an event relating to the incident;
evaluate the detected event; and
propagate via at least one alerting site service at least one disruption alert associated with the incident, wherein the at least one disruption alert is based upon evaluating the detected event, and wherein the at least one alerting site service distributes the at least one disruption alert to at least one alerting agent among a plurality of alerting agents, each of the at least one alerting agent being associated with a respective virtual machine within the environment that is affected by the incident.

11. The computer program product of claim 10, further comprising:
upon resolution of the incident, propagating via the at least one alerting site service at least one resumption alert.

12. The computer program product of claim 10, further comprising:
propagating at least one anticipated alert responsive to a predictive alert technique based upon analysis of historical trends.

13. The computer program product of claim 10, further comprising:
propagating at least one anticipated alert responsive to a failure of at least one element within the environment.

14. The computer program product of claim 10, wherein evaluating the detected event comprises:
determining attributes of the detected event;
calculating a probability value indicating potential impact severity with respect to the detected event; and
registering the detected event.

15. The computer program product of claim 10, wherein the at least one alerting agent is registered to at least one designated alerting site service among the at least one alerting site service such that the at least one designated alerting site service processes the at least one disruption alert by automatically triggering at least one action customized to at least one guest operating system application of any respective virtual machine within the environment that is associated with the at least one alerting agent.

16. A system comprising:
a processor; and
a memory storing an application program, which, when executed on the processor, performs an operation comprising:
receiving a notification regarding an incident in an environment in which computing capabilities are provided as a service;
monitoring a plurality of events within the environment to detect an event relating to the incident;
evaluating the detected event; and
propagating via at least one alerting site service at least one disruption alert associated with the incident, wherein the at least one disruption alert is based upon evaluating the detected event, and wherein the at least one alerting site service distributes the at least one disruption alert to at least one alerting agent among a plurality of alerting agents, each of the at least one alerting agent being associated with a respective virtual machine within the environment that is affected by the incident.

17. The system of claim 16, further comprising:
upon resolution of the incident, propagating via the at least one alerting site service at least one resumption alert.

18. The system of claim 16, further comprising:
propagating at least one anticipated alert responsive to a predictive alert technique based upon analysis of historical trends.

19. The system of claim 16, further comprising:
propagating at least one anticipated alert responsive to a failure of at least one element within the environment.

20. The system of claim 16, wherein evaluating the detected event comprises:
determining attributes of the detected event;
calculating a probability value indicating potential impact severity with respect to the detected event; and
registering the detected event.
